(19) United States
(12) Patent Application Publication
(10) Pub. No.: US 2026/0255444 A1
(43) Pub. Date: Aug. 27, 2026

(54) PROCESSES AND APPARATUSES FOR HEATING A PROCESS FLUID

(71) Applicant: UOP LLC, Des Plaines, IL (US)

(72) Inventors: Chintan Surendra Shah, Ahmedabad (IN); Phillip F. Daly, Palatine, IL (US)

(21) Appl. No.: 19/322,370

(22) Filed: Sep. 8, 2025

Related U.S. Application Data
(60) Provisional application No. 63/763,557, filed on Feb. 26, 2025.

(51) Int. Cl. H05B 1/02

(52) U.S. Cl. CPC H05B 1/0244

(57) ABSTRACT

Processes and apparatuses for heating a process fluid with an electric heater by controlling one or more process conditions based on information about the process. The electric heater uses a working fluid to transfer heat from an electrical heating element to the process fluid. The working fluid is recirculated in a loop. A controller is configured to receive the information and adjust a condition based on the received information.

### RELATED APPLICATIONS

This application claims priority to United States Provisional Patent Application Ser. No. 63/763,557, filed on Feb. 26, 2025, the entire disclosure of which is incorporated herein by reference.

### FIELD OF THE INVENTION

This invention relates generally to processes and apparatuses for heating a process fluid, and more particularly to processes and apparatuses for heating a process fluid with an electrical heater.

### BACKGROUND OF THE INVENTION

As a result of the Paris agreement and the Net Zero agreement initiative, there is an increased desire to reduce carbon footprint(s) and utilize greener fuels, hydrogen firing, and maximizing green electricity heating. While there are existing electric heaters, they are limited and may not be best suited for a variety of heating applications. For example, electric immersion or impedance heating for liquid and two-phase hydrocarbons is not feasible due to variety of risks covering film temperature issues and increased risk of coking.

Accordingly, it would be desirable to have an electric heater which overcomes the limitations of immersion and impedance heating and is not limited to gas-only applications.

### SUMMARY OF THE INVENTION

The present inventors have developed a new electric heater and with the new heater, systems and methods that utilize the new heater to overcome the disadvantages in existing electric heaters.

Therefore, the present invention may be characterized, in at least one aspect, as providing a system having: an electric heater, the electric heater comprising a housing, an inlet for a process fluid, an outlet for the process fluid, an inlet for a working fluid, an outlet for the working fluid, and an electrical heating element configured to transfer heat to the working fluid within the housing; and, at least one controller configured to: receive at least one information relating to the system, the process fluid, the working fluid, the electrical heating element, or any combination thereof; and adjust at least one process condition based on the at least one information.

The at least one process condition may be an electrical input to the electrical heating element.

The at least one process condition may be a molecular composition of the working fluid.

The at least one process condition may be a flow rate of the working fluid to the electric heater.

The at least one information may be a molecular composition of the working fluid.

The at least one information may be a temperature of the working fluid at the inlet, or a temperature of the working fluid at the outlet, or a combination thereof.

The working fluid may include ambient air, gaseous water, carbon dioxide, sulfur dioxide, other gaseous, inert or polar molecules, or any combination thereof.

The controller may be further configured to: determine that a shutdown has occurred; and, after determining that the shutdown has occurred, adjust a composition of the working fluid.

The system may also include a plurality of monitoring devices, each monitoring device configured to provide an information to the controller.

The present invention may also be generally characterized as providing a process for transferring heat to a process fluid by: passing a process fluid into an electric heater; passing a working fluid into the electric heater; passing an electric current into an electrical heating element of the electric heater in order to heat the working fluid within the electric heater; receiving, by at least one controller, at least one information relating the process fluid, the working fluid, the electrical heating element, or any combination thereof; and, adjusting at least one process condition based on the at least one information.

The working fluid may include ambient air, gaseous water, carbon dioxide, sulfur dioxide, other gaseous, inert or polar molecules, or any combination thereof.

The at least one process condition may be an electrical input to the electrical heating element.

The at least one process condition may be a molecular composition of the working fluid.

The at least one process condition may be a flow rate of the working fluid to the electric heater.

The at least one information may be a molecular composition of the working fluid.

The at least one information may be a temperature of the working fluid at an inlet of the electric heater, or a temperature of the working fluid at an outlet of the electric heater, or a temperature of the process fluid at the a process fluid outlet of the electric heater, or a differential pressure of the process fluid between a pressure at a process fluid outlet and a process fluid inlet, or any combination thereof.

The process may also include: determining, by the at least one controller, that a shutdown has occurred; and, after determining that the shutdown has occurred, adjusting a composition of the working fluid.

The process may further include: circulating the working fluid in a closed, recirculation loop. The closed, recirculation loop may be a negative pressure loop. The process may additionally include: bypassing, in the closed, recirculation loop, the electric heater with a portion of the working fluid.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

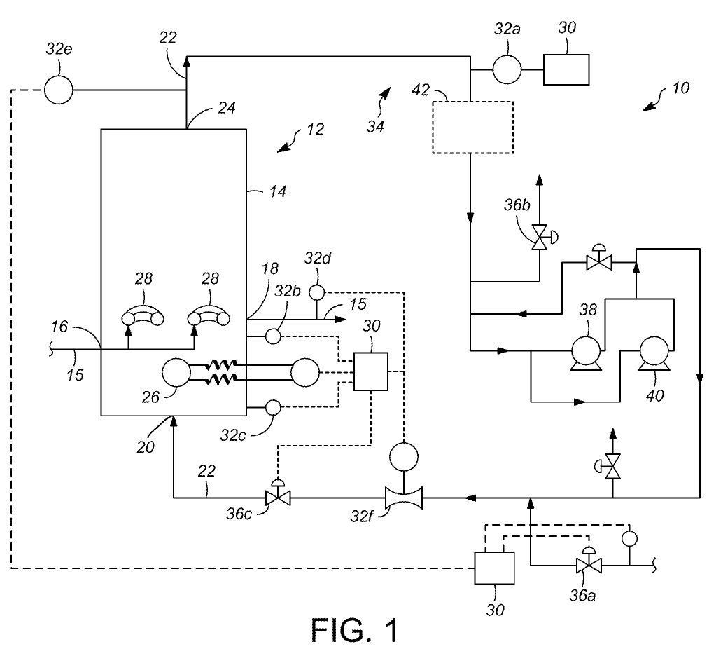

FIG. 1 is a schematic of a process flow diagram according to one or more embodiments of the present invention;

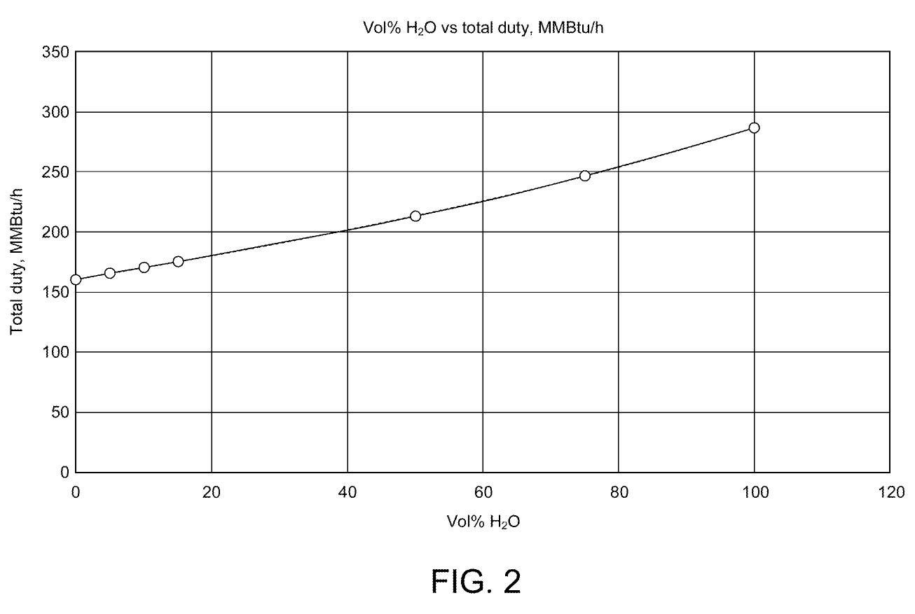

FIG. 2 is a graph comparing amount of water to total heat duty; and,

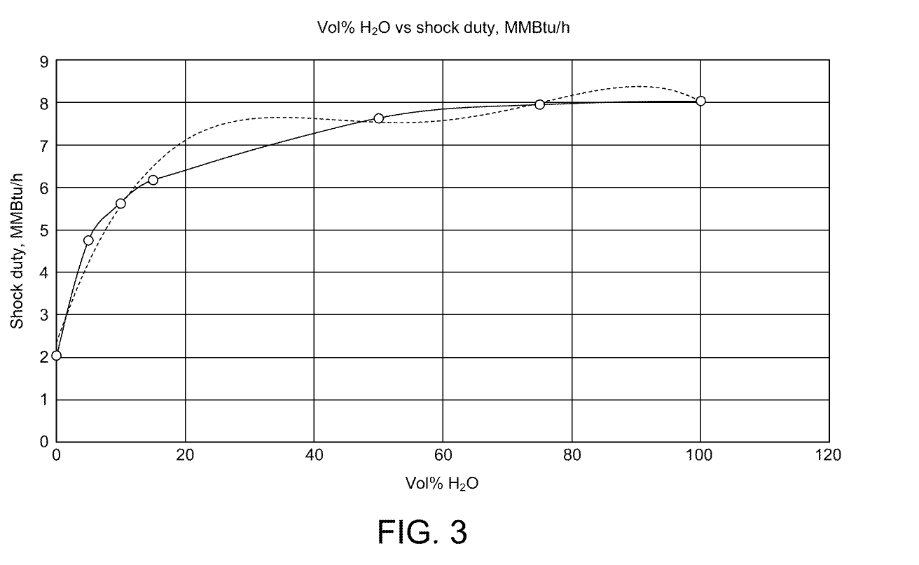

FIG. 3 is a graph comparing amount of water to shock/radiation duty.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understating the embodiments of the present invention.

In general, the same reference numbers will be used throughout the drawing(s) and accompanying written description to refer to the same or like parts.

### DETAILED DESCRIPTION OF THE INVENTION

As mentioned above, the present inventors have developed a new electric heater and with the new electric heater, systems and methods that utilize the new electric heater to overcome the disadvantages in existing electric heaters. In the invented electric heater, a working fluid, which is preferably an inert medium/heat carrier medium, which flows through the electric heater to transfer heat from an electric heating element to a process fluid contained within conduits within the electric heater. The working fluid is preferably an inert medium/heat carrier medium can be broadly characterized as any medium which has heat carrying capability and thermal properties by virtue of temperature and composition (for example ambient air, polar molecules, H₂O, CO₂, SO₂ etc.) which when employed for heat transfer achieve the targeted results of heating process/bulk fluid to its targeted temperature/terminal conditions while facilitating modulation of heat input from source (in this case electric heating elements). In some embodiments, one or more additives may be added to the working fluid to enhance heat transfer including, but not limited to, helium, argon and xenon

The electric heating elements may be arranged in multiple ways and layers. The electric input to electric heating elements may be controlled based on, for example, an outlet temperature measurement of the working fluid or by also considering the temperature differential and flow rate of the working fluid across the electric heating elements or directly by the process/bulk fluid outlet temperature (outlet from the electric heater).

The electricity input controller, which may be based on a temperature or differential temperature of the working fluid or directly by the process fluid outlet temperature, may also receive a remote set point from the flow controller of the working fluid, so the heat input in form of electricity input is controlled based on the flow modulation. This can help the electric heating elements better control the working fluid outlet temperature, and can avoid excessive working fluid temperatures and unnecessarily high electric heating element temperatures.

The temperature measurement of the working fluid downstream of the electric heater is utilized to minimize the working fluid exceeding a temperature that would result in mechanical damage to the impeller and other components of a fan, a blower, a turbine, a compressor, a pump, and any combination thereof.

If the temperature of working fluid downstream of the electric heater increases, then the controller/damper in the air intake can open (or increase the amount it is open) to reduce the temperature by taking in ambient air. Additionally, and/or alternatively, a valve downstream of the fans/blowers may open (or increase the amount it is open) to bypass the electric heater and protect rotating equipment integrity. To further protect overheating of the electric heating elements and to mitigate excessive radiant impact on components of electric heating elements, an interlock based on low flow trip point of the working fluid the electricity input to electric heating elements may be cut off/tripped. It is further contemplated that a cold sink is provided upstream of a fan, a blower, a turbine, a compressor, a pump, and any combination thereof to reject heat and control working fluid temperature at inlet of a fan, a blower, a turbine, a compressor, a pump, and any combination thereof.

Moreover, it is believed that the composition of working fluid impacts the entire heat transfer. For example, as the polar molecules (for example steam%) increases in the circulating working fluid, then the overall performance of the electric heater in terms of imparting duty to the process fluid, as well as electricity demand for heating, can be optimized. Accordingly, composition control is useful and can be achieved by, for example, monitoring the O₂% in working fluid. If 100% of the working fluid is H₂O then the O₂ monitor should read zero or near zero, whereas when there is no H₂O in working fluid the O₂ reading will be 20.9-21%.

It is also believed that shock duty (due to combination of radiation from electric heating elements and molecular radiation from the working fluid) also impacts the overall heat transfer and the tube wall temperature of the rows of the process fluid those are directly exposed to electric heating elements and heated working fluid. An increase of shock duty and improvement in overall heat transfer due to composition change of working fluid may facilitate in optimizing the surface area of the conduits with the process coils (as a heat sink) to optimize overall size and cost of the electric heater, as improve thermal properties and in turn improve the overall heat transfer co-efficient (including impact of inside process fluid heat transfer co-efficient and outside tube working fluid heat transfer co-efficient), leading to better heat transfer even from reduced/optimized surface area.

In a planned shutdown wherein the working fluid is one of polar molecule, such as H₂O, then a planned action can be taken to introduce ambient air flow, stop superheated steam (source of H₂O), and open a purge valve to gradually purge out steam/H₂O (polar molecule) from the system and have full replacement of air by monitoring O₂%. This mitigates the risk of large quantity of condensate accumulation inside entire system as a result of a shutdown.

For unplanned or emergency shutdown, the system may automatically purge and remove moisture to maximum extent, while removing condensates (if any) from low point drains at multiple locations in the system.

The electric heater, and recirculation loop of the working fluid, is preferably operated in negative pressure, i.e. draft to ensure that the hot working fluid is not leaking to outside atmosphere and the energy is not lost to atmosphere. Thus, the fans/blowers will be sized accordingly and depending on the hydraulic profile can be called either Induced draft or Forced draft fans/blowers. Further operating in negative pressure (draft) and mitigation of risk of leak of hot working fluid to vicinity can prevent loss of such medium (and associated need of continuous replenishment), damage to equipment, instruments, structural members etc. in vicinity and ensures safety of operators/human movement in and around the electric heater. However, depending on the need, the electric heater/system may be pressurized/positive pressure as well and the recirculation loop of the working fluid may be operated in positive pressure.

The working fluid, once it reaches a steady state (composition and circulation rate wise), is preferably in closed loop circulation so that no additional fluid is required. This provides a system that does not require continuous consumption of working fluid for heat transfer.

A bypass with a control element can be provided from a fan, a blower, a turbine, a compressor, a pump, and any combination thereof, such bypass will be normally no flow, but on need basis to control the temperature at the inlet of such rotating equipment one can bypass and mix the discharge stream with suction, such control can also be used when say the electric heater is operating at lower duties out of process reasons and is desired to avoid losing working fluid by purge to the atmosphere. The net circulation rate around the rotating equipment can be managed by such a bypass, while allowing controlled/required flow of working fluid through the electric heater.

Finally, the circulation rate of working fluid also impacts heat transfer, as the heat transfer co-efficient of working fluid is directly proportional to its mass velocity. Therefore, adjusting the mass velocity/circulation rate of the working fluid may facilitate heat transfer control.

With these general principles in mind, one or more embodiments of the present invention will be described with the understanding that the following description is not intended to be limiting.

Turning to FIG. 1 a system 10 according to one or more embodiments, includes at least one electric heater 12. Each electric heater 12 has a housing 14, an inlet 16 for a process fluid 15, an outlet 18 for the process fluid 15, an inlet 20 for a working fluid 22, an outlet 24 for the working fluid 22, and an electrical heating element 26 configured to transfer heat to the working fluid 22 within the housing 14. The working fluid 22, after being heated by the electric heating element 26, heats the process fluid 15 within conduits 28 within the housing 14. The shape, arrangement, and number of conduits 28 and electric heating elements 26 is not necessarily important for the present invention.

The working fluid 22 may be ambient air, gaseous water, carbon dioxide, sulfur dioxide, other gaseous, inert or polar molecules, or any combination thereof. Additionally, the working fluid 22 may include molecules and or additives that improve the thermal properties of the working fluid 22.

The system 10 also includes at least one controller 30 that is configured to receive at least one information relating to the system 10, the process fluid 15, the working fluid 22, the electrical heating element 26, or any combination thereof. Based on the received information the at least one controller 30 is configured to adjust at least one process condition associated with heating the process fluid 15 within the electric heater 12.

The at least one information may be a temperature of the working fluid 22 at the inlet 20, or a temperature of the working fluid 22 at the outlet 24, or a combination thereof. The at least one information may be a temperature of the process fluid 15 or a temperature of the heating element 26. The at least one information may be a pressure of the process fluid 15 and/or the working fluid 22.

Any of these temperatures or pressures may be obtained with monitoring devices 32a, 32b, 32c, 32d such as temperature sensors, pressure sensors, or probes. The monitoring devices 32 may be arranged in a recirculation loop 34 for the working fluid 22, and/or in the electric heater 12, and/or may be associated with the process fluid 15. The monitoring devices 32 are in communication with the at least one controller 30.

Additionally, and/or alternatively, the at least one information may be a molecular composition of the working fluid 22. For example, a monitoring device 32e, such as an oxygen sensor or probe may be arranged in the recirculation loop 34 for the working fluid 22. Again, this monitoring device 32e is in communication with the at least one controller 30. It should be appreciated that the monitoring device 32e may be configured to measure and/or determine a different molecule, such as water, sulfur dioxide, or any other molecule that is used in the working fluid 22. Furthermore, it is contemplated that at least one monitoring device 32e is configured to measure or determine the presence of combustible gases or hydrocarbons. This information would be utilized to indicate that there may be a leak of process fluid 15.

Additionally, and/or alternatively, the at least one information may be a flow rate of the working fluid 22. This may be measured with a monitoring devices 32f such as a flow meter.

Additionally, and/or alternatively, the at least one information may be a an amount of electricity currently supplied to the heating element 26.

As mentioned above, based on the at least one information, the at least one controller 30 is configured to adjust at least one process condition associated with the system 10 and/or electric heater 12.

For example, the process condition that is adjusted may be an electrical input to the electrical heating element 26. As would be appreciated, an increased electrical input to the electrical heating element 26 will increase the temperature of same because the electrical heating element 26 uses the electrical input to generate heat. Similarly, a decreased electrical input to the electrical heating element 26 will decrease the temperature of same.

Additionally, and/or alternatively, the at least one process condition may be a molecular composition of the working fluid 22. For example, water, oxygen, or air or an additive (not limited to helium, argon or xenon) may be added into the working fluid 22 so as to change the molecular composition of the working fluid to achieve different properties of the working fluid 22. This can be adjusted by, for example, opening a valve 36a to add additional working fluid 22 (such as air, oxygen or water). The composition may also be adjusted by opening a valve 36b to vent or remove some of the working fluid 22 from the recirculation loop 34.

Additionally, and/or alternatively, the at least one process condition may be a flow rate of the working fluid 22, or process fluid 15, or both to the electric heater 12. As mentioned above, the flow rate of the working fluid 22 will impact the heat transfer within the electric heater. Similarly, the flow rate of the process fluid 15 will impact the amount of time the process fluid 15 is within the electric heater 12. These process conditions may be adjusted by, for example, adjusting a variable control valve 36c. These flow rate of the working fluid 22 may also be adjusted based on increasing or deceasing the power of a fan, a blower, a turbine, a compressor, a pump, and any combination thereof 38, 40 in the recirculation loop 34.

The system may also include a heat sink 42 in the recirculation loop 34 to aid in adjusting, controlling, or reducing the temperature of the working fluid 22.

Generally, a process for transferring heat to the process fluid 15 according to at least one aspect of the present disclosure includes passing the process fluid 15 into the electric heater 12 and passing the working fluid 22 into the electric heater 12. An electric current is provided to the electrical heating element 26 of the electric heater 12. As is known, the electrical heating element 26 generates heat from the current which is transferred to the working fluid 22 within the electric heater 12. As the working fluid moves within the electric heater 12, the working fluid 22 will contact the conduits 28 with the process fluid 15 and transfer heat to the process fluid 15.

At least one controller receives at least one information relating the process fluid 15, the working fluid 22, the electrical heating element 26, or any combination thereof. Based on the received information, at least one process condition is adjusted. The received information may be compared against values, such as a threshold or a target, which may be stored in a database or dynamically determined by a controller 30.

The working fluid 22 may be circulated in the recirculation loop 34. It is contemplated that the recirculation loop 34 is a negative pressure recirculation loop which reduce the losses of working fluid, however, it is possible that the recirculation loop 34 is a positive pressure recirculation loop or has a combination of different sections, some operating under negative pressure, and others operating under positive pressure.

It is also contemplated that one or portions of the working fluid 22 may bypass various sections including, for example, the electric heater 12. In an aspect, a portion of the working fluid 22 may circulate back to a fan, a blower, a turbine, a compressor, a pump, and any combination thereof 38/40 instead of being passed to the electric heater 12.

In is further contemplated that the controller 30 may determine, from the information received or from a signal, that a shutdown has occurred and the process fluid 15 no longer needs to be heated. The shutdown may be planned, or it may be unplanned. Once it has been determined that a shutdown has occurred, the controller 30 may adjust a composition of the working fluid 22. The controller may also adjust further conditions, such as reducing an electrical input to the electric heating element 26 and/or reducing a flow rate of the working fluid 22.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

### Experiments

Turning to FIG. 2, a graph is shown depicting the impact of the composition of the working fluid on the heat capacity of the working fluid. To demonstrate the impact, an amount of H₂O was changed while the temperature of working fluid entering the process coils bundle/module remained constant, the surface area of process coils was constant, and the circulation rate of working fluid was constant. As can be seen in FIG. 2, the increased amount of H₂O showed an increase in heat carrying capacity of the working fluid. Thus, by changing the composition of the working fluid, the heat carrying capacity of the working fluid could be adjusted to achieve changes in heat transfer.

Turning to FIG. 3, based on the same experimental conditions, an increase in the amount of H₂O (polar molecules) in the working fluid, showed an appreciable increase in shock duty. Again, this supports the conclusion that by changing the composition of the working fluid, changes in the heat transfer from the working fluid to the process fluid may be achieved.

### Specific Embodiments

While the following is described in conjunction with specific embodiments, it will be understood that this description is intended to illustrate and not limit the scope of the preceding description and the appended claims.

A first embodiment of the invention is a system comprising an electric heater, the electric heater comprising a housing, an inlet for a process fluid, an outlet for the process fluid, an inlet for a working fluid, an outlet for the working fluid, and an electrical heating element configured to transfer heat to the working fluid within the housing; and, at least one controller configured to receive at least one information relating to the system, the process fluid, the working fluid, the electrical heating element, or any combination thereof; adjust at least one process condition based on the at least one information. An embodiment of the invention is one, any or all of prior embodiments in this paragraph up through the first embodiment in this paragraph, wherein the at least one process condition comprises an electrical input to the electrical heating element. An embodiment of the invention is one, any or all of prior embodiments in this paragraph up through the first embodiment in this paragraph, wherein the at least one process condition comprises a molecular composition of the working fluid. An embodiment of the invention is one, any or all of prior embodiments in this paragraph up through the first embodiment in this paragraph, wherein the at least one process condition comprises a flow rate of the working fluid to the electric heater. An embodiment of the invention is one, any or all of prior embodiments in this paragraph up through the first embodiment in this paragraph, wherein the at least one information comprises a molecular composition of the working fluid. An embodiment of the invention is one, any or all of prior embodiments in this paragraph up through the first embodiment in this paragraph, wherein the at least one information comprises a temperature of the working fluid at the inlet, or a temperature of the working fluid at the outlet, or a combination thereof. An embodiment of the invention is one, any or all of prior embodiments in this paragraph up through the first embodiment in this paragraph, wherein the working fluid comprises ambient air, gaseous water, carbon dioxide, sulfur dioxide, other gaseous, inert or polar molecules, or any combination thereof. An embodiment of the invention is one, any or all of prior embodiments in this paragraph up through the first embodiment in this paragraph, wherein the controller is further configured to determine that a shutdown has occurred; and, after determining that the shutdown has occurred, adjust a composition of the working fluid. An embodiment of the invention is one, any or all of prior embodiments in this paragraph up through the first embodiment in this paragraph further comprising a plurality of monitoring devices, each monitoring device configured to provide an information to the controller.

A second embodiment of the invention is a process for transferring heat to a process fluid, the process comprising passing a process fluid into an electric heater; passing a working fluid into the electric heater; passing an electric current into an electrical heating element of the electric heater in order to heat the working fluid within the electric heater; receiving, by at least one controller, at least one information relating the process fluid, the working fluid, the electrical heating element, or any combination thereof; and, adjusting at least one process condition based on the at least one information. An embodiment of the invention is one, any or all of prior embodiments in this paragraph up through the second embodiment in this paragraph, wherein the working fluid comprises ambient air, gaseous water, carbon dioxide, sulfur dioxide, other gaseous, inert or polar molecules, or any combination thereof. An embodiment of the invention is one, any or all of prior embodiments in this paragraph up through the second embodiment in this paragraph, wherein the at least one process condition comprises an electrical input to the electrical heating element. An embodiment of the invention is one, any or all of prior embodiments in this paragraph up through the second embodiment in this paragraph, wherein the at least one process condition comprises a molecular composition of the working fluid. An embodiment of the invention is one, any or all of prior embodiments in this paragraph up through the second embodiment in this paragraph, wherein the at least one process condition comprises a flow rate of the working fluid to the electric heater. An embodiment of the invention is one, any or all of prior embodiments in this paragraph up through the second embodiment in this paragraph, wherein the at least one information comprises a molecular composition of the working fluid. An embodiment of the invention is one, any or all of prior embodiments in this paragraph up through the second embodiment in this paragraph, wherein the at least one information comprises a temperature of the working fluid at an inlet of the electric heater, or a temperature of the working fluid at an outlet of the electric heater, or a temperature of the process fluid at the a process fluid outlet of the electric heater, or a differential pressure of the process fluid between a pressure at a process fluid outlet and a process fluid inlet, or any combination thereof. An embodiment of the invention is one, any or all of prior embodiments in this paragraph up through the second embodiment in this paragraph, further comprising determining, by the at least one controller, that a shutdown has occurred; and, after determining that the shutdown has occurred, adjusting a composition of the working fluid. An embodiment of the invention is one, any or all of prior embodiments in this paragraph up through the second embodiment in this paragraph, further comprising circulating the working fluid in a closed, recirculation loop. An embodiment of the invention is one, any or all of prior embodiments in this paragraph up through the second embodiment in this paragraph, wherein the closed, recirculation loop comprises a negative pressure loop. An embodiment of the invention is one, any or all of prior embodiments in this paragraph up through the second embodiment in this paragraph, further comprising bypassing, in the closed, recirculation loop, the electric heater with a portion of the working fluid.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A system comprising:
an electric heater, the electric heater comprising a housing, an inlet for a process fluid, an outlet for the process fluid, an inlet for a working fluid, an outlet for the working fluid, and an electrical heating element configured to transfer heat to the working fluid within the housing; and,
at least one controller configured to:
receive at least one information relating to the system, the process fluid, the working fluid, the electrical heating element, or any combination thereof;
adjust at least one process condition based on the at least one information.

2. The system of claim 1, wherein the at least one process condition comprises an electrical input to the electrical heating element.

3. The system of claim 1, wherein the at least one process condition comprises a molecular composition of the working fluid.

4. The system of claim 1, wherein the at least one process condition comprises a flow rate of the working fluid to the electric heater.

5. The system of claim 1, wherein the at least one information comprises a molecular composition of the working fluid.

6. The system of claim 1, wherein the at least one information comprises a temperature of the working fluid at the inlet, or a temperature of the working fluid at the outlet, or a combination thereof.

7. The system of claim 1, wherein the working fluid comprises ambient air, gaseous water, carbon dioxide, sulfur dioxide, other gaseous, inert or polar molecules, or any combination thereof.

8. The system of claim 1, wherein the controller is further configured to:
determine that a shutdown has occurred; and,
after determining that the shutdown has occurred, adjust a composition of the working fluid.

9. The system of claim 1 further comprising:
a plurality of monitoring devices, each monitoring device configured to provide an information to the controller.

10. A process for transferring heat to a process fluid, the process comprising:
passing a process fluid into an electric heater;
passing a working fluid into the electric heater;
passing an electric current into an electrical heating element of the electric heater in order to heat the working fluid within the electric heater;
receiving, by at least one controller, at least one information relating the process fluid, the working fluid, the electrical heating element, or any combination thereof; and,
adjusting at least one process condition based on the at least one information.

11. The process of claim 10, wherein the working fluid comprises ambient air, gaseous water, carbon dioxide, sulfur dioxide, other gaseous, inert or polar molecules, or any combination thereof.

12. The process of claim 10, wherein the at least one process condition comprises an electrical input to the electrical heating element.

13. The process of claim 10, wherein the at least one process condition comprises a molecular composition of the working fluid.

14. The process of claim 10, wherein the at least one process condition comprises a flow rate of the working fluid to the electric heater.

15. The process of claim 10, wherein the at least one information comprises a molecular composition of the working fluid.

16. The process of claim 10, wherein the at least one information comprises a temperature of the working fluid at an inlet of the electric heater, or a temperature of the working fluid at an outlet of the electric heater, or a temperature of the process fluid at the a process fluid outlet of the electric heater, or a differential pressure of the process fluid between a pressure at a process fluid outlet and a process fluid inlet, or any combination thereof.

17. The process of claim 10, further comprising:
determining, by the at least one controller, that a shutdown has occurred; and,
after determining that the shutdown has occurred, adjusting a composition of the working fluid.

18. The process of claim 10, further comprising:
circulating the working fluid in a closed, recirculation loop.

19. The process of claim 18, wherein the closed, recirculation loop comprises a negative pressure loop.

20. The process of claim 18, further comprising:
bypassing, in the closed, recirculation loop, the electric heater with a portion of the working fluid.
